(19) United States
(12) Patent Application Publication
(10) Pub. No.: US 2026/0024192 A1
(43) Pub. Date: Jan. 22, 2026

(54) IMAGE INSPECTION APPARATUS, IMAGE FORMING SYSTEM, IMAGE INSPECTION METHOD, AND NON-TRANSITORY RECORDING MEDIUM

(71) Applicant: Shinya NOHDOMI, Kanagawa (JP)

(72) Inventor: Shinya NOHDOMI, Kanagawa (JP)

(21) Appl. No.: 19/243,921

(22) Filed: Jun. 20, 2025

(30) Foreign Application Priority Data
Jul. 19, 2024 (JP) 2024-115841

(51) Int. Cl. G06T 7/00; G06K 15/00; G06K 15/02; G06T 7/60

(52) U.S. Cl. CPC G06T 7/001; G06K 15/005; G06K 15/027; G06T 7/60; G06T 2207/30144

(57) ABSTRACT

An image inspection apparatus includes circuitry to read a recording medium on which an image is formed by an image forming apparatus to acquire an inspection target image, determine whether a defect is present on the recording medium based on the inspection target image and a master image to be compared with the inspection target image, in a case that the defect is detected on the recording medium based on the master image and the inspection target image, determine post-detection processing to be executed in response to an occurrence of the defect, the post-detection processing having been determined in advance for the defect based on a priority determined in advance according to a type of the defect, and execute the post-detection processing.

### CROSS-REFERENCE TO RELATED APPLICATION

This patent application is based on and claims priority pursuant to 35 U.S.C. § 119 (a) to Japanese Patent Application No. 2024-115841, filed on Jul. 19, 2024, in the Japan Patent Office, the entire disclosure of which is hereby incorporated by reference herein.

### BACKGROUND

### Technical Field

The present disclosure relates to an image inspection apparatus, an image forming system, an image inspection method, and a non-transitory recording medium.

### Related Art

In the related art, as a technique for checking whether a defect is present on a printed matter on which an image is formed, a technique for comparing a scanned image obtained by scanning the printed matter with an image to be compared with the scanned image has been proposed. As the image to be compared with the scanned image, an original document image that is the source of the printed matter or an image generated from the original document image may be used. When it is determined that a defect is present on the created printed matter based on a result of the comparison, processing (i.e., recovery processing) in accordance with post-detection processing set in advance for the defect is executed.

For example, a technique has been disclosed, in which post-detection processing for a defect is set in advance for each type of defect, and when a defect is detected, subsequent processing is executed without interruption.

### SUMMARY

The present disclosure described herein provides an image inspection apparatus including circuitry to read a recording medium on which an image is formed by an image forming apparatus to acquire an inspection target image, determine whether a defect is present on the recording medium based on the inspection target image and a master image to be compared with the inspection target image, in a case that the defect is detected on the recording medium based on the master image and the inspection target image, determine post-detection processing to be executed in response to an occurrence of the defect, the post-detection processing having been determined in advance for the defect based on a priority determined in advance according to a type of the defect, and execute the post-detection processing.

In another aspect, an image forming system includes an image forming apparatus to form an image on a recording medium and an image inspection apparatus including circuitry to read the recording medium to acquire an inspection target image, determine whether a defect is present on the recording medium based on the inspection target image and a master image to be compared with the inspection target image, in a case that the defect is detected on the recording medium based on the master image and the inspection target image, determine post-detection processing to be executed in response to an occurrence of the defect, the post-detection processing having been determined in advance for the defect based on a priority determined in advance according to a type of the defect, and execute the post-detection processing.

In another aspect, an image inspection method includes reading a recording medium on which an image is formed by an image forming apparatus to acquire an inspection target image, determining whether a defect is present on the recording medium based on the inspection target image and a master image to be compared with the inspection target image, in a case that the defect is detected on the recording medium based on the master image and the inspection target image, determining post-detection processing to be executed in response to an occurrence of the defect, the post-detection processing having been determined in advance for the defect based on a priority determined in advance according to a type of the defect, and executing the post-detection processing.

In another aspect, a non-transitory recording medium stores a plurality of program codes which, when executed by one or more processors, causes the one or more processors to perform the method described above.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram illustrating a configuration of an image forming system including an image inspection apparatus;

FIG. 2 is a block diagram illustrating a hardware configuration of an image inspection apparatus;

FIG. 3 is a schematic diagram illustrating a configuration of an image forming apparatus, an image inspection apparatus, and a stacker according to a first embodiment;

FIG. 4 is a block diagram illustrating a functional configuration of an image inspection apparatus;

FIG. 5 is a diagram illustrating a priority table;

FIG. 6 is a diagram illustrating another type of priority table;

FIG. 7 is a diagram illustrating still another type of priority table;

FIG. 8 is a diagram illustrating still another type of priority table;

FIG. 9 is a diagram illustrating a setting screen used for setting information in the priority table of FIG. 5;

FIG. 10 is a diagram illustrating a setting screen used for setting information in the priority table of FIG. 6;

FIG. 11 is a diagram illustrating a setting screen used for setting information in the priority table of FIG. 7;

FIG. 12 is a diagram illustrating a setting screen used for setting information in the priority table of FIG. 8;

FIG. 13 is a block diagram illustrating a functional configuration of a digital front end (DFE);

FIG. 14 is a block diagram illustrating a functional configuration of an image forming apparatus;

FIG. 15 is a diagram illustrating contents of job management information;

FIGS. 16A and 16B are flowcharts of an image inspection processing executed in an image inspection apparatus; and

FIG. 17 is a diagram illustrating a print pause screen.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An image inspection apparatus, an image forming system, an image inspection method, and a non-transitory recording medium are described in detail below with reference to the accompanying drawings. The techniques according to the embodiments of the present disclosure are applicable not only to an electrophotographic system but also to an inkjet printing system.

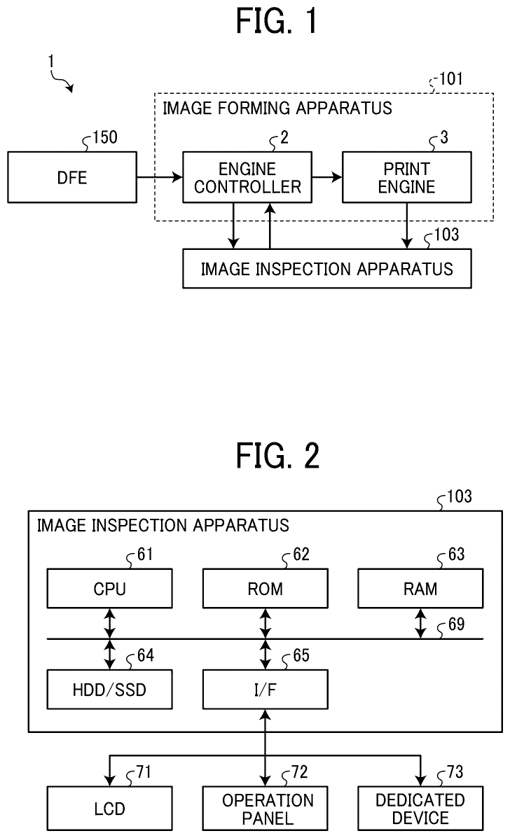

FIG. 1 is a block diagram illustrating a configuration of an image forming system 1 including an image inspection apparatus 103. As illustrated in FIG. 1, the image forming system 1 includes a digital front end (DFE) 150, an image forming apparatus 101, and the image inspection apparatus 103.

The image forming system 1 executes appropriate processing in accordance with the type of defect on a printed matter. The image forming system 1 is an image forming system including the image inspection apparatus 103 for inspecting an output result (i.e., a document image) by comparing a scanned image (i.e., a read image) obtained by reading the output result output through an image forming process with a master image (i.e., a sample image).

The DFE 150 generates image data to be printed out, that is, bitmap data that is an output target image, based on a print job received from a host machine. The DFE 150 outputs the generated bitmap data to an engine controller 2. As the host machine, a general-purpose personal computer (PC) or an information processing apparatus such as a server may be used as appropriate.

The image forming apparatus 101 executes image formation and output and forms an image on a recording medium. The image forming apparatus 101 includes the engine controller 2 and a print engine 3.

The engine controller 2 controls the print engine 3 to form and output an image based on the bitmap data (i.e., document image data) received from the DFE 150. Also, the engine controller 2 transmits the bitmap data received from the DFE 150 to the image inspection apparatus 103 as information serving as the master image. The master image is an image to which the image inspection apparatus 103 refers when inspecting a result of image formation and output executed by the print engine 3.

Under the control of the engine controller 2, the print engine 3 executes image formation and output on a sheet as the recording medium based on the bitmap data and inputs the image formation and output to the image inspection apparatus 103. As the recording medium, in addition to the sheet described above, a sheet-like material on which an image can be formed and output, such as a film or a plastic sheet, may be used.

The image inspection apparatus 103 generates master image data (also referred to as sample image data) representing a master image (also referred to as a sample image) to be compared with the scanned image, based on the bitmap data input from the engine controller 2. The image inspection apparatus 103 compares the scanned image input from the print engine 3 with the master image to inspect the output result (i.e., the document image).

The image inspection apparatus 103 is an apparatus that detects a defect on the scanned image by comparing the scanned image input from the print engine 3 with the master image.

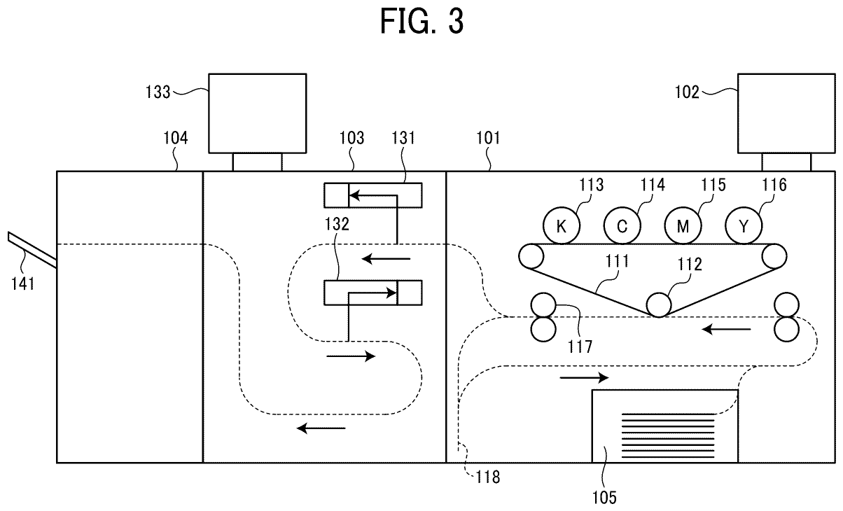

The hardware configurations of the DFE 150, the engine controller 2, the print engine 3, and the image inspection apparatus 103 in the image forming system 1 according to one aspect of the present disclosure are described below with reference to FIG. 2. FIG. 2 is a block diagram illustrating a hardware configuration of the image inspection apparatus 103.

Although the hardware configuration of the image inspection apparatus 103 is primarily described with reference to FIG. 2, the hardware configurations of the DFE 150, the engine controller 2, and the print engine 3 are substantially the same as the hardware configuration of the image inspection apparatus 103.

Note that at least two of the DFE 150, the engine controller 2, the print engine 3, and the image inspection apparatus 103 in the image forming system 1 may be integrally configured as a single unit. For example, the engine controller 2 and the print engine 3 may be integrated into one apparatus such as the image forming apparatus 101. The integrated apparatus has substantially the same hardware configuration as the hardware configuration of the image inspection apparatus 103 described below.

The image inspection apparatus 103 has substantially the same hardware configuration as a hardware configuration of an information processing apparatus such as a general-purpose PC or server. As an example, as illustrated in FIG. 2, the image inspection apparatus 103 includes a central processing unit (CPU) 61, a read-only memory (ROM) 62, a random-access memory (RAM) 63, a hard disk drive/solid-state drive (HDD/SSD) 64, and an interface (I/F) 65. The CPU 61, the ROM 62, the RAM 63, the HDD/SSD 64, and the I/F 65 communicate with one another via, for example, a bus 69.

The CPU 61 is a calculator or a processor. The CPU 61 controls the overall operation of the image inspection apparatus 103. The ROM 62 is a read-only nonvolatile storage medium. The ROM 62 stores programs such as firmware. The RAM 63 is a volatile storage medium that reads and writes information at high speed. The RAM 63 is used as a work area for the CPU 61 to process (or calculate) information. The HDD/SSD 64 is a nonvolatile storage medium that reads and writes information. The HDD/SSD 64 stores, for example, an operating system (OS), various control programs, and application programs.

Instead of the CPU 61, any one of various calculators or processors such as a graphics processing unit (GPU), an application-specific integrated circuit (ASIC), and a field-programmable gate array (FPGA) may be used.

As the HDD/SSD 64, an HDD and an SSD may be used, or either one of the HDD and the SSD may be used. The HDD/SSD 64 is not limited to the HDD and the SSD, and a storage device such as a flash memory or a compact disc-read-only memory (CD-ROM) may be used as appropriate.

The I/F 65 is an interface circuit that connects the bus 69 to various kinds of hardware components or a network and controls the connection (i.e., the communication). In FIG. 2, a liquid crystal display (LCD) 71, an operation panel 72, and a dedicated device 73 are connected to the I/F 65.

The LCD 71 is a visual user interface (serving as a display device) for a user to check the state of the image inspection apparatus 103. The operation panel 72 is a user interface (serving as an input device) for the user to input information to the image inspection apparatus 103, such as a keyboard or a mouse. The LCD 71 and the operation panel 72 may be integrally configured as a touch panel display. The LCD 71 is an example of a display (display device).

The dedicated device 73 is a hardware component that implements a dedicated function in each of the engine controller 2, the print engine 3, and the image inspection apparatus 103. In the case of the print engine 3, examples of the dedicated device 73 include, but are not limited to, a plotter that forms and outputs an image on a sheet of paper and a reading device that reads an image output on a sheet of paper. In the case of the engine controller 2 or the image inspection apparatus 103, the dedicated device 73 is an arithmetic device dedicated to high-speed image processing. Such an arithmetic device is configured, for example, as an ASIC.

In such a hardware configuration, a program stored in a storage medium such as the ROM 62, the HDD/SSD 64, or an optical disk is read out to the RAM 63, and the CPU 61 executes calculation according to the program loaded onto the RAM 63, thus functioning as a software controller. A combination of the software controller and the hardware components configures functional blocks to implement respective functions of the engine controller 2, the print engine 3, and the image inspection apparatus 103.

A control program executed by each of the DFE 150, the engine controller 2, the print engine 3, and the image inspection apparatus 103 in the image forming system 1 according to one aspect of the present disclosure is stored in any computer-readable storage medium, such as a compact disc read-only memory (CD-ROM), a flexible disk (FD), a compact disc-recordable (CD-R), or a digital versatile disc (DVD), in an installable or executable file format and provided as a computer program product.

Alternatively, the program to be executed by each of the DFE 150, the engine controller 2, the print engine 3, and the image inspection apparatus 103 in the image forming system 1 according to one aspect of the present disclosure may be configured to be stored in a computer connected to a network such as the Internet and provided by being downloaded via the network. Further, the program to be executed by each of the DFE 150, the engine controller 2, the print engine 3, and the image inspection apparatus 103 in the image forming system 1 according to one aspect of the present disclosure may be configured to be provided or distributed via a network such as the Internet.

Furthermore, the program to be executed by each of the DFE 150, the engine controller 2, the print engine 3, and the image inspection apparatus 103 in the image forming system 1 according to one aspect of the present disclosure may be incorporated in, for example, a ROM in advance and provided.

FIG. 3 is a schematic diagram illustrating a configuration of the image forming apparatus 101, the image inspection apparatus 103, and a stacker 104 according to a first embodiment. In FIG. 3, a configuration in which the image forming apparatus 101, the image inspection apparatus 103, and the stacker 104 are combined is illustrated.

The image inspection apparatus 103 is configured in combination with the image forming apparatus 101 and the stacker 104 as illustrated in FIG. 3. Alternatively, the image inspection apparatus 103 may be configured as a standalone apparatus separately from the image forming apparatus 101 or may be configured in combination with another apparatus other than the image forming apparatus 101.

An operation panel 102 displays various information on the image forming apparatus 101 and receives various operations from the user.

The image forming apparatus 101 receives a print job including a raster image processor (RIP) image from an external device or an instruction to execute a print job stored in the image forming apparatus 101 and executes image formation processing on a sheet using an image forming components in accordance with the contents of the print job. The image forming apparatus 101 may be configured to form an image not only on a sheet but on any recording medium on which an image can be formed.

As illustrated in FIG. 3, the image forming apparatus 101 includes a sheet feeder 105, and image forming components such as drums 113, 114, 115, and 116, a belt 111, a roller 112, a roller pair 117, and a reverse path 118.

Specifically, the image forming apparatus 101 controls each mechanical component to acquire a sheet from the sheet feeder 105 in the lower portion of the image forming apparatus 101 and convey the sheet along a path indicated by a dotted line in FIG. 3.

Toner images of black (K), cyan (C), magenta (M), and yellow (Y) formed on the drums 113, 114, 115, and 116, respectively, by an optical writing device based on an image for printing are superimposed on the belt 111.

The roller 112 transfer the composite toner image from the belt 111 onto the sheet to be conveyed. The roller pair 117 fixes the composite toner image onto the sheet. In the case of single-sided printing, the sheet is ejected to the image inspection apparatus 103 without any other process.

In the case of double-sided printing, the sheet is reversed in the reverse path 118. Then, another composite toner image is also transferred and fixed onto the back side of the sheet and the sheet is ejected to the image inspection apparatus 103.

The image inspection apparatus 103 is an apparatus for inspecting the printed matter printed and output by the image forming apparatus 101. The printed matter is an example of a “recording medium.” As illustrated in FIG. 3, the image inspection apparatus 103 includes an operation panel 133 and reading devices 131 and 132.

The operation panel 133 includes a display for displaying various screens and receives various operation inputs from the user through the display. In the present embodiment, the image inspection apparatus 103 is provided with the operation panel 133. However, the operation panel 102 of the image forming apparatus 101 may also serve as the operation panel 133 of the image inspection apparatus 103. In addition, the operation panel 102 of the image forming apparatus 101 or the operation panel 133 of the image inspection apparatus 103 may be an information processing apparatus such as a PC connected to the image forming apparatus via a local area network (LAN).

Each of the reading devices 131 and 132 reads the printed matter with a line sensor or an image sensor and outputs a scanned image.

The stacker 104 is provided with a tray 141. The stacker 104 stacks the printed matter ejected from the image inspection apparatus 103 on the tray 141.

### Functional Configuration of Image Inspection Apparatus

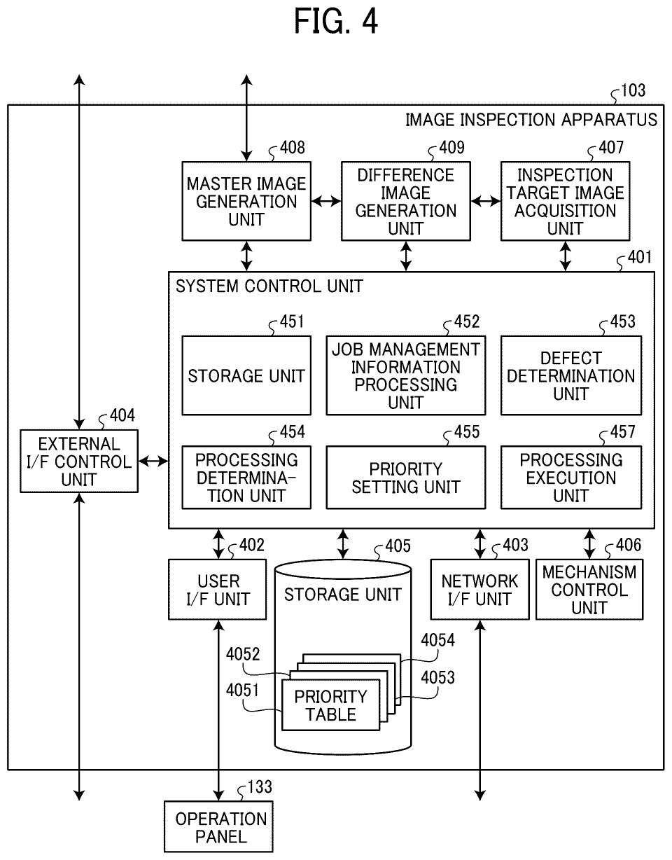

FIG. 4 is a block diagram illustrating a functional configuration of the image inspection apparatus 103. As illustrated in FIG. 4, the image inspection apparatus 103 includes a system control unit 401, a user I/F unit 402, a network I/F unit 403, an external I/F control unit 404, a storage unit 405, a mechanism control unit 406, an inspection target image acquisition unit 407, a master image generation unit 408, and a difference image generation unit 409.

The user I/F unit 402, which may be implemented by an interface circuit, is an interface for connecting the system control unit 401 and the operation panel 133. The network I/F unit 403, which may be implemented by an interface circuit, is an interface for connecting the system control unit 401 to a network such as the LAN. The external I/F control unit 404, which may be implemented by an interface circuit, is an interface for connection to external devices. The storage unit 405 is a storage device implemented by, for example, an HDD or an SSD. The mechanism control unit 406 is a control unit for controlling the operation of an inspection apparatus such as sheet conveyance.

The inspection target image acquisition unit 407 acquires the scanned image (read image) obtained by each of the reading devices 131 and 132 scanning the printed matter ejected from the image forming apparatus 101. In the following description, the scanned image is referred to as an inspection target image.

The master image generation unit 408 generates, from the RIP image, a master image serving as a comparison image to be compared with the inspection target image. The difference image generation unit 409 generates a difference image between the master image and the inspection target image.

The system control unit 401 controls the overall operation of the image inspection apparatus 103. As illustrated in FIG. 4, the system control unit 401 includes a storage unit 451, a job management information processing unit 452, a defect determination unit 453, a processing determination unit 454, a priority setting unit 455, and a processing execution unit 457.

The storage unit 451 is a storage medium implemented by, for example, a RAM, an HDD, or an SSD. In the storage unit 451, a consecutive occurrence flag is stored. The consecutive occurrence flag is a flag indicating whether a defect has occurred consecutively across multiple pages in the inspection target image (i.e., the scanned image of the printed matter). The consecutive occurrence flag set to on indicates that a defect has occurred consecutively across multiple pages. The consecutive occurrence flag set to off indicates that a defect has not occurred consecutively across multiple pages. The consecutive occurrence flag is set by the defect determination unit 453 to be described later.

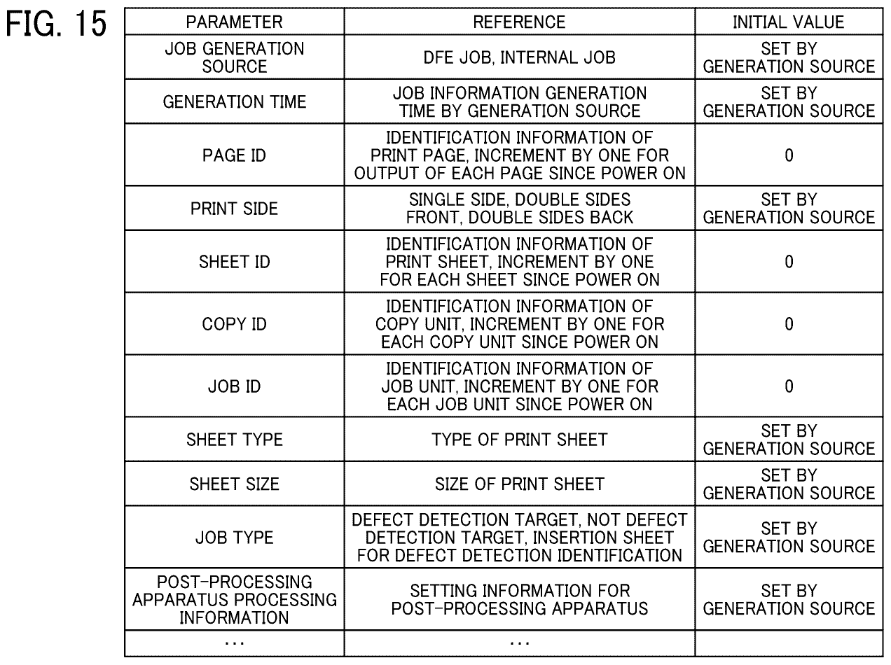

The system control unit 401 receives job management information via the external I/F control unit 404 and controls the storage unit 451 in the system control unit to store the job management information. The system control unit 401, with the job management information processing unit 452, extracts post-processing apparatus processing information from job management information illustrated in FIG. 15, transmits the post-processing apparatus processing information to the stacker 104 that is a post-processing apparatus operating at a stage subsequent to the operation of the image inspection apparatus 103 via the external I/F control unit 404, extracts print management information, and transfers the print management information to the master image generation unit 408, the difference image generation unit 409, the inspection target image acquisition unit 407, and the mechanism control unit 406.

The print management information transferred at this time is the job management information illustrated in FIG. 15 from which the post-processing apparatus processing information is removed. The job management information will be described in detail later.

The system control unit 401 controls the storage unit 451 to store the inspection target image and the difference image and notifies the defect determination unit 453 and the processing determination unit 454 of the storage.

The defect determination unit 453 determines whether a defect is present on the printed matter based on image the inspection target image and the master image to be compared with the inspection target. Specifically, the defect determination unit 453 compares the pixel value of the difference image generated by the difference image generation unit 409 with a threshold value used for image inspection. In the case where the pixel value is determined to be larger than the threshold value, the defect determination unit 453 determines that a defect is present on the inspection target image, that is, detects a defect. The defect on the inspection target image corresponds to a defect in the result (i.e., the printed matter) of the image formation and output executed by the image forming apparatus 101.

The defect determination unit 453 obtains defect information for each defective image (i.e., each inspection target image having a defect) that includes the detected defective pixel. The defect information includes the position of the defective pixel constructing the defective image on the image and the difference value at the defective pixel. In addition, the defect determination unit 453 groups defective images based on the position of each defect on the image. In other words, the defect determination unit 453 recognizes the defective images at distant positions as different defective images.

As described above, the defect determination unit 453 compares a distance between the defective pixels with a threshold value used for searching for a defective region. When the distance between the defective pixels is determined to be equal to or less than the threshold value, the defect determination unit 453 recognizes that the defective pixels construct the same defective image. By contrast, when the distance between the defective pixels exceeds the threshold value, the defect determination unit 453 recognizes that the defective pixels construct different defective images. In other words, the defect information includes information on each defective image grouped together.

The defect determination unit 453 calculates a feature amount for each defective image and determines the type of defect based on the calculated feature amount. In addition, the defect determination unit 453 calculates a level that indicates the degree of defect for each defective image. Levels range, for example, from a level 1 to a level 5, and the smaller the level number, the greater the degree of defect. In the present embodiment, the level of the size of the defect and the level of the density of the defect are used.

For example, it is assumed that multiple types of defects and respective calculation formulas of levels are defined in advance and stored in the HDD/SSD 64. When the difference between the vertical length and the lateral length of a defect is determined to be small, the defect determination unit 453 determines that the defective image is a defect in the form of a small point, which is referred to as a dot in the following description. For example, when the area of a defect is determined to be large to some extent and the difference between the vertical length and the lateral length of the defect is determined to be large, the defect determination unit 453 determines that the defective image is a defect in the form of a line, which is referred to as a vertical streak or lateral streak depending on the inclination of the line in the following description. As the vertical length (or the lateral length) of the defect, the length on the printed matter may be used. Alternatively, the number of pixels constructing the defective image may be used. As described above, the image inspection apparatus 103 according to one aspect of the present disclosure obtains the feature of the detected defective image and determines, based on the obtained feature, the defect on the detected defective image to be one of the types of defects defined in advance.

When a defect is detected on the inspection target image by the defect determination unit 453, the processing determination unit 454 determines post-detection processing determined in advance for the defect based on a priority determined in advance according to the type of defect to which the detected defect belongs. The post-detection processing is processing to be executed when a defect is detected. In the present embodiment, when a defect is detected on the inspection target image by the defect determination unit 453, the processing determination unit 454 refers to a priority table and determines the post-detection processing for the defect. The priority table is a table in which the priority of the post-detection processing is defined. In the priority table, the type of defect, the post-detection processing, and the priority are associated with one another. Priority tables 4051 to 4054 are stored in the storage unit 405.

Specifically, when a defect is detected by the defect determination unit 453, the processing determination unit 454 determines the post-detection processing for the type of defect which the detected defect belongs to and has the highest priority in the priority tables 4051 to 4054.

In the priority tables 4051 to 4054, when the size level or density level of the defect is associated with the post-detection processing for each type of defect, the processing determination unit 454 determines the post-detection processing for the size level or density level of the detected defect. The level indicates the degree of the size or density of the defect as described above.

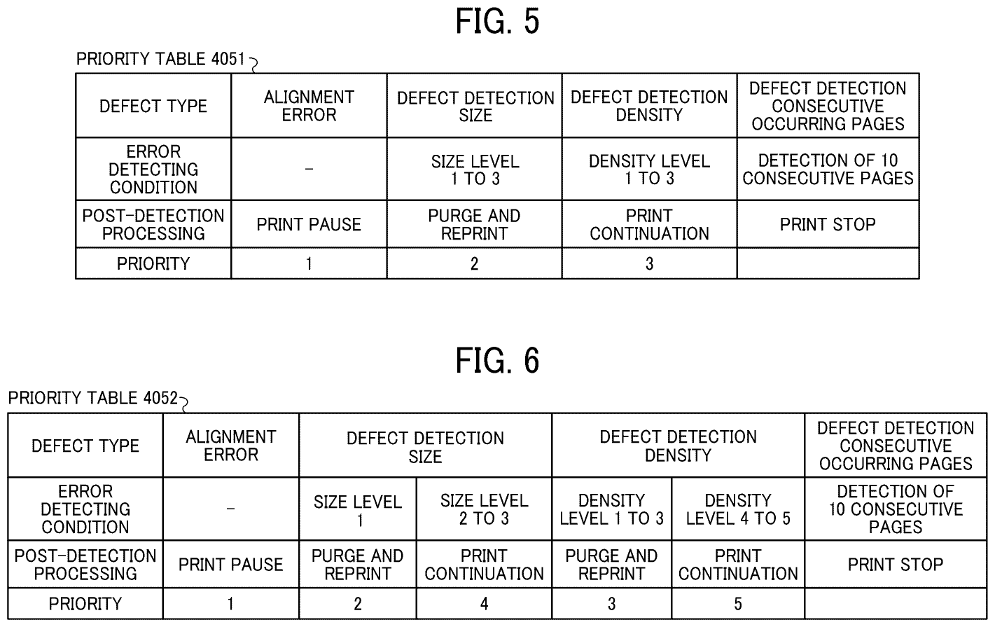

FIG. 5 is a diagram illustrating the priority table 4051. In FIG. 5, the post-detection processing is set by type of defect and error.

In the priority table 4051 illustrated in FIG. 5, the size level or density level of a defect detected before execution of printing, the number of pages when a defect is detected consecutively on multiple pages, and an occurrence of an alignment error when the alignment error is detected at a defect inspection are set. Also, the post-detection processing to be executed when each defect or error is detected is set. The alignment error is an error that indicates a deviation occurring when the master image and the inspection target image are compared.

Since a defect may occur on consecutive pages, the number of consecutive pages when the same defect detected on consecutive pages is to be detected as a defect and the post-detection processing for the defect are registered in the priority table 4051 in association with each other. The number of consecutive pages may also be referred to as consecutive occurring pages in the following description.

In the case of FIG. 5, for the alignment error, “print pause” is set as the post-detection processing. For defects of the size levels 1 to 3, “purge and reprint” is set as the post-detection processing. For defects of the density levels 1 to 3, “print continuation” is set as the post-detection processing. Further, “print stop” is set as the post-detection processing when the same defect is detected on ten consecutive pages.

The priority is a value that indicates the priority of the post-detection processing to be executed when multiple defects are detected. The smaller the value of the priority, the higher the priority. It is assumed that a defect of a size level 2 and another defect of a density level 2 are detected on the same page. In the case of FIG. 5, since a priority 2 is set to the size level 2 and a priority 3 is set to the density level 2, the processing determination unit 454 gives priority to the size level 2 and determines the post-detection processing to be the “purge and reprint.”

FIG. 6 is a diagram illustrating the priority table 4052, which is another type of priority table. In the case of FIG. 6, similarly to the priority table 4051 in FIG. 5, the post-detection processing and a priority are set for the alignment error, and an error detecting condition and the post-detection processing are set for the consecutive occurring pages. In FIG. 6, a different type of post-detection processing is set for each type of defect or error and for each range of the level of each type of defect. In other words, in the priority table 4052 of FIG. 6, multiple ranges of different levels are set for the size or density, and the post-detection processing is set for each of the multiple ranges of the different levels.

Specifically, in the priority table 4052, the “purge and reprint” is set as the post-detection processing for a defect of the size level 1, and the “print continuation” is set as the post-detection processing for defects of the size levels 2 to 3. Further, the “purge and reprint” is set as the post-detection processing for defects of the density levels 1 to 3, and the “print continuation” is set as the post-detection processing for defects of the density levels 4 to 5.

It is assumed that a defect of a size level 2 and another defect of a density level 2 are detected on the same page. Since a priority 4 is set to the size level 2 and a priority 3 is set to the density level 2, the processing determination unit 454 gives priority to the density level 2 and determines the post-detection processing to be the “purge and reprint.”

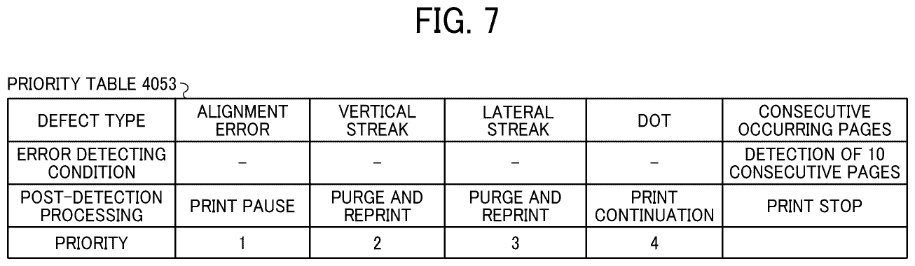

FIG. 7 is a diagram illustrating the priority table 4053, which is still another type of priority table. In the case of FIG. 7, similarly to the priority table 4051 in FIG. 5, the post-detection processing and a priority are set for the alignment error, and an error detecting condition and the post-detection processing are set for the consecutive occurring pages. Further, in the priority table 4053 illustrated in FIG. 7, the post-detection processing and the priority are set for the shape of the defect in association with each other. In the case of FIG. 7, a vertical streak (vertical line), a lateral streak (lateral line), and a dot (point) are presented as examples of the shape of the defect, but the shape of the defect is not limited thereto. In the priority table 4053, as the post-detection processing, the “purge and reprint” is set for the vertical streak, the “purge and reprint” is set for the lateral streak, and the “print continuation” is set for the dot.

It is assumed that a vertical streak and a dot are detected on the same page. Since a priority 2 is set to the vertical streak and a priority 4 is set to the dot, the processing determination unit 454 gives priority to the vertical streak and determines the post-detection processing to be the “purge and reprint.”

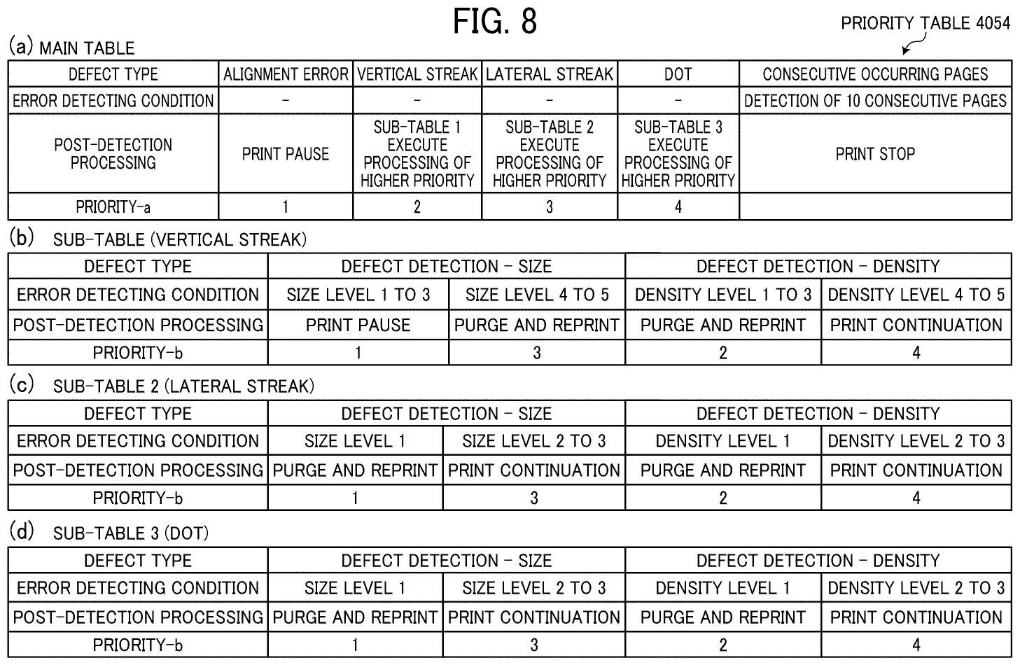

FIG. 8 is a diagram illustrating the priority table 4054, which is still another type of priority table. In the priority table 4054 of FIG. 8, the post-detection processing and a priority are set for each type of defect or error. In addition, the types of defects are classified by shape of defect such as the vertical streak, lateral streak, or dot, and the post-detection processing and the priority are set for each of the multiple ranges of different levels by shape of defect.

Specifically, the priority table 4054 is formed of a main table illustrated in part (a) of FIG. 8 and three sub-tables illustrated in parts (b) to (d) of FIG. 8. In the main table of part (a) of FIG. 8, similarly to the priority table 4051 in FIG. 5, the post-detection processing and a “priority-a” are set for the alignment error, and an error detecting condition and the post-detection processing are set for the consecutive occurring pages. Further, in the priority table 4054, the post-detection processing and the priority-a are set for each of the vertical streak, the lateral streak, and the dot, and the post-detection processing is set to refer to a sub-table.

In other words, a sub-table 1 in part (b) of FIG. 8 is set to be referred to for a defect having a vertical streak, a sub-table 2 in part (c) of FIG. 8 is set to be referred to for a defect having a lateral streak, and a sub-table 3 in part (d) of FIG. 8 is set to be referred to for a defect having a dot. That is, in the sub-table, the post-detection processing for the shape of the defect having the highest priority among the shapes of the defects detected on the same page is set. In each sub-table, similarly to the priority table 4052 in FIG. 6, a different type of post-detection processing is set for each of multiple ranges of different levels in the size or density of the defect.

In the case of the vertical streak, for example, in the sub-table 1, the post-detection processing and a “priority-b” are set according to the size level or density level. The “print pause” is set as the post-detection processing for defects of the size levels 1 to 3, and the “purge and reprint” is set as the post-detection processing for defects of the size levels 4 to 5. Further, the “purge and reprint” is set as the post-detection processing for defects of the density levels 1 to 3, and the “print continuation” is set as the post-detection processing for defects of the density levels 4 to 5. The same applies to the sub-tables 2 and 3.

It is assumed that a defect having a vertical streak of the size level 2, another defect having a vertical streak of the density level 2, and still another defect having a lateral streak of the size level 1 are detected on the same page. First, since the vertical streak has a higher priority than the lateral streak in the comparison of the priority-a, the processing determination unit 454 gives priority to the post-detection processing for the defects having a vertical streak. Further, since the size level 2 has a higher priority than the density level 2 in the comparison of the priority-b, the processing determination unit 454 gives priority to the size level 2 and determines the post-detection processing to be the “print pause.”

When determining the post-detection processing, the processing determination unit 454 may refer to any of the priority tables 4051 to 4054, and the priority table to be referred to is determined in advance. The multiple priority tables 4051 to 4054 may be stored in the storage unit 451.

Referring back to FIG. 4, the processing execution unit 457 executes the post-detection processing determined by the processing determination unit 454.

The priority setting unit 455 registers, in the priority tables 4051 to 4054, the post-detection processing and the priority in association with each other for each type of defect according to an instruction by the user. Specifically, the priority setting unit 455 displays, on the display of the operation panel 133, a setting screen that allows the user to input the post-detection processing and a priority in association with each other for each type of defect, and registers the type of defect, the post-detection processing, and the priority input by the user through the setting screen in association with one another in the priority tables 4051 to 4054.

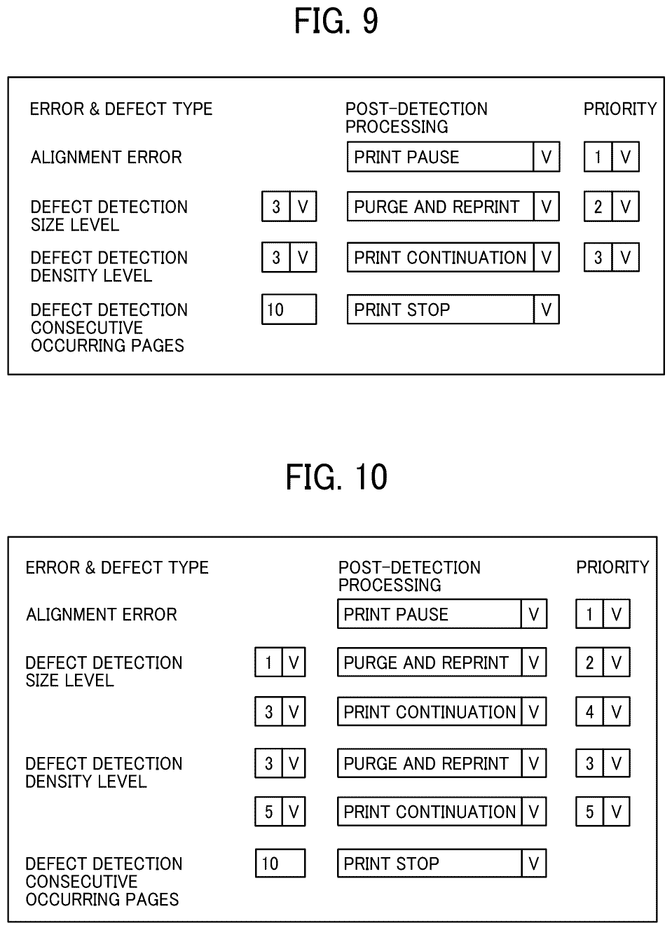

The setting screen is described below. FIG. 9 is a diagram illustrating the setting screen. The setting screen in FIG. 9 is a screen used for setting items in the priority table 4051 illustrated in FIG. 5. As illustrated in FIG. 9, on the setting screen, a list box in which the setting of the size level of the defect, the setting of the density level of the defect, the setting of the post-detection processing, and the setting of the priority can be designated for each type of error and defect is displayed. On this setting screen, the user designates an item as desired for each type of error and defect as the size level of the defect, the density level of the defect, the post-detection processing, or the priority among the items displayed in the list box. The designated items are registered in the priority table 4051 in association with one another by the priority setting unit 455. For example, the post-detection processing and the priority can be set for the type of error and defect. As the post-detection processing, one of the “print continuation,” the “purge and reprint,” “sheet insertion and reprint,” the “print pause,” and “print stop” can be selected. The level of the defect can be set. Both the size level and the density level can be set from 1 to 5, and the level 1 is the highest defective level. The priority can be set for each type and level of the defect, and the priority can be set in order from 1 to the type of the defect having the highest priority.

FIG. 10 is a diagram illustrating another type of setting screen. The setting screen in FIG. 10 is a screen used for setting items in the priority table 4052 illustrated in FIG. 6. As illustrated in FIG. 10, on the setting screen, a list box in which the setting of the size level of the defect, the setting of the density level of the defect, the setting of the post-detection processing, and the setting of the priority can be designated for each type of error and defect as illustrated in FIG. 9 is displayed. In addition, on this setting screen, the user is allowed to designate an item as desired for each size level or density level by type of defect as the post-detection processing and the priority among the items displayed in the list box. The priority setting unit 455 registers the items designated on the setting screen in the priority table 4052 in association with one another.

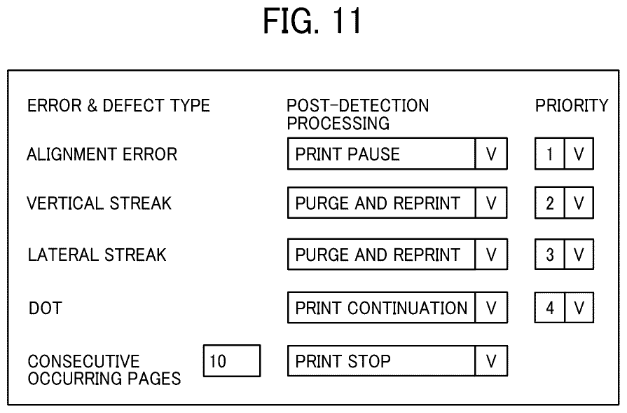

FIG. 11 is a diagram illustrating still another type of setting screen. The setting screen in FIG. 11 is a screen used for setting items in the priority table 4053 illustrated in FIG. 7. Unlike the setting screen illustrated in FIG. 9, on which the size level of the defect, the density level of the defect, the post-detection processing, and the priority can be designated for each type of error and defect, on this setting screen, the items of the post-detection processing and the priority can be designated for each shape of the defect (i.e., a vertical streak, a lateral streak, or a dot) by type of defect. The priority setting unit 455 registers the items designated on the setting screen in the priority table 4053 in association with one another.

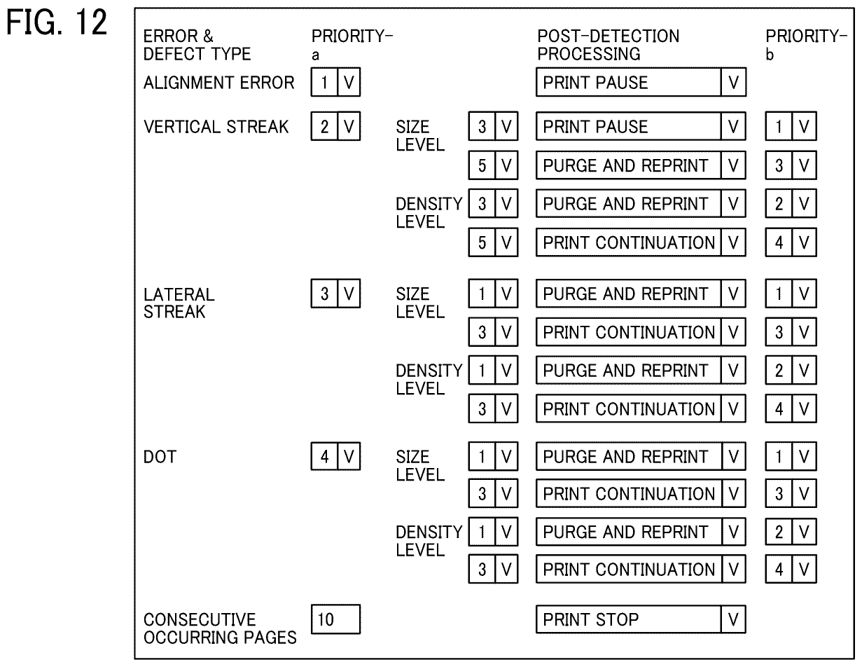

FIG. 12 is a diagram illustrating still another type of setting screen. The setting screen in FIG. 12 is a screen used for setting items in the priority table 4054 illustrated in FIG. 8. On the setting screen, similarly to FIG. 11, the priority (i.e., the priority-a) can be designated for each shape of the defect by type of defect. Further, similarly to FIG. 10, for each shape of the defect, the post-detection processing and the priority (i.e., the priority-b) can be designated for each detected size level or density level of the defect by type of defect. The priority setting unit 455 registers the items designated on the setting screen in the priority table 4054 in association with one another.

### Digital Front End (DFE)

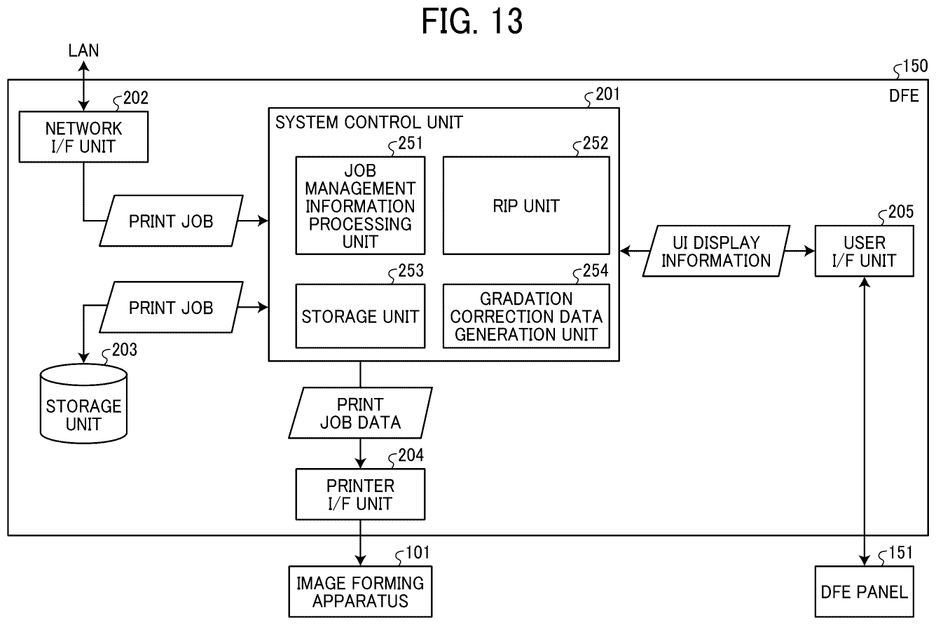

The DFE 150 is described in detail below. FIG. 13 is a block diagram illustrating a functional configuration of the DFE 150 that corresponds to an image generation controller. The DFE 150 includes a system control unit 201, a network I/F unit 202, a storage unit 203, a printer I/F unit 204, and a user I/F unit 205.

The network I/F unit 202, which may be implemented by an interface circuit, is an interface for connection to the LAN.

The storage unit 203 is a storage medium implemented by, for example, an HDD or an SSD.

The printer I/F unit 204, which may be implemented by an interface circuit, is an interface for connecting to the image forming apparatus 101.

The user I/F unit 205, which may be implemented by an interface circuit, is an interface for connecting to the DFE panel 151.

The DFE panel 151 is a device for displaying a user interface (UI) used for inputting and outputting information from and to the user.

As illustrated in FIG. 13, the system control unit 201 includes a job management information processing unit 251, a RIP unit 252, a storage unit 253, and a gradation correction data generation unit 254. The job management information processing unit 251 processes a print job and converts the print job into job management information and RIP image data. The storage unit 253 temporarily stores data. The gradation correction data generation unit 254 generates gradation correction data.

The system control unit 201 transmits, as print job data, the job management information and the RIP image data to the image forming apparatus 101 via the printer I/F unit 204.

### Configuration of Image Forming Apparatus

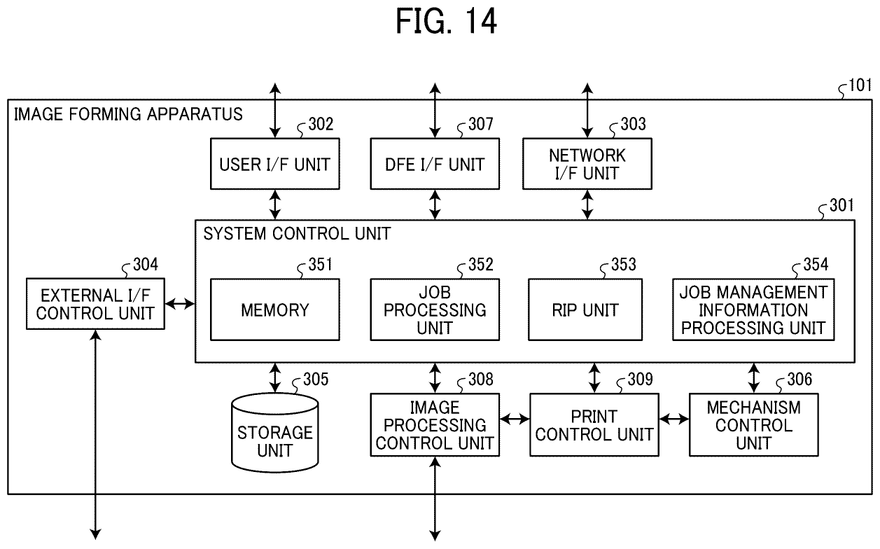

The configuration of the image forming apparatus 101 is described in detail below. FIG. 14 is a block diagram illustrating a functional configuration of the image forming apparatus 101. As illustrated in FIG. 14, the image forming apparatus 101 includes a system control unit 301, a user I/F unit 302, a network I/F unit 303, an external I/F control unit 304, a storage unit 305, a mechanism control unit 306, a DFE I/F unit 307, an image processing control unit 308, and a print control unit 309.

The user I/F unit 302, which may be implemented by an interface circuit, is an interface for connecting the system control unit 301 and the operation panel 102 to each other. The network I/F unit 303, which may be implemented by an interface circuit, is an interface for connecting the system control unit 301 to a network such as the LAN. The external I/F control unit 304, which may be implemented by an interface circuit, is an interface for connection to other devices. The storage unit 305 is a storage device such as a hard disk. The mechanism control unit 306 is a control unit for controlling the operation of the image forming apparatus 101, such as the sheet conveyance and the transfer process in the image forming apparatus 101. The DFE I/F unit 307, which may be implemented by an interface circuit, is an interface for transferring a RIP image to an image generation controller (e.g., the DFE) connected to the image forming apparatus 101 as an external device. The image processing control unit 308 processes the print image transferred by the mechanism control unit 306. The print control unit 309 controls image formation on a sheet to create a printed matter.

The system control unit 301 controls the overall operation of the image forming apparatus 101. As illustrated in FIG. 14, the system control unit 301 includes a memory 351, a job processing unit 352, a RIP unit 353, and a job management information processing unit 354.

The job processing unit 352 processes the print job and generates job management information and RIP image data.

The RIP unit 353 converts print data included in the print job into RIP image data.

The job management information processing unit 354 generates job management information. The job management information indicates the processing content of the print job, and the print processing is executed based on the job management information.

FIG. 15 is a diagram illustrating the contents of the job management information. As illustrated in FIG. 15, in the job management information, parameters such as a “job generation source,” a “generation time,” a “page identification (ID),” a “print side,” a “sheet ID,” a “copy ID,” a “job ID,” a “sheet type,” a “sheet size,” a “job type,” and “post-processing apparatus processing information” are set.

The “job generation source” is information indicating a source that outputs a job. The information contains information indicating whether the job is a job output from the DFE 150 (i.e., a DFE job) or a job using internal data (i.e., an internal job) in the image forming apparatus 101. The “generation time” is information indicating the date and time when the job generation source has generated the job management information.

The “page ID” is an identification number of a printed page. The page ID is incremented by one for each page processed since the power on. A numerical value is set to the page ID when printing is executed.

The “print side” is information for identifying whether the print image is to be printed on one side, or on the front side (double-sided front) or on the back side (double-sided back) in double-sided printing.

The “sheet ID” is identification information of a sheet used for printing. In the case of double-sided printing, pages printed on the same sheet have the same sheet ID. The sheet ID is incremented by one for each sheet processed since the power on. A numerical value is set to the sheet ID when printing is executed.

The “copy ID” is identification information for each copy unit. The copy ID is incremented by one for each time the output of a copy unit is completed since the power on. A numerical value is set to the copy ID when printing is executed.

The “job ID” is identification information for each job. The job ID is incremented by one for each time the output of a job is completed since the power on. A numerical value is set to the job ID when printing is executed.

The “sheet type” is information on a type of a sheet used for printing. The “sheet size” is information on the size of the sheet.

The “job type” is information indicating whether the print job is a print job subjected to defect detection or a print job not subjected to defect detection, or whether the print job involves an insertion sheet used for identifying defect detection. The image inspection apparatus 103 may not be able to inspect some types of sheets for a defect, such as a colored sheet. The print job subjected to defect detection indicates that the defect detection is performed for the print job. On the other hand, the print job not subjected to defect detection indicates that the defect detection is not performed for the print job.

An “initial value” is information indicating a value when the system control unit 301 receives the information. The “post-processing apparatus processing information” is setting information for a post-processing apparatus such as the stacker 104.

### Image Inspection Processing

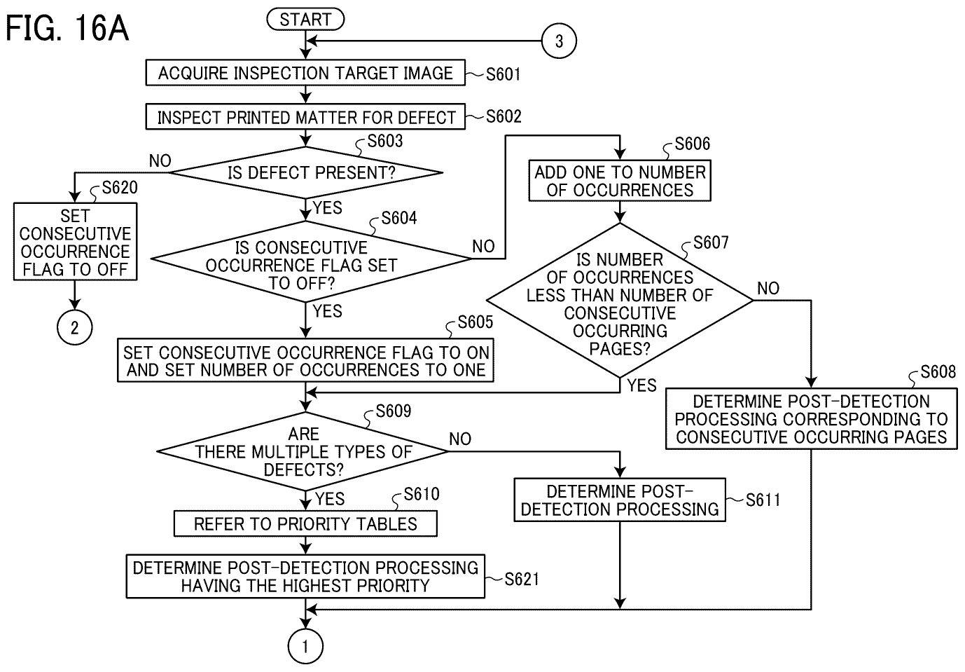

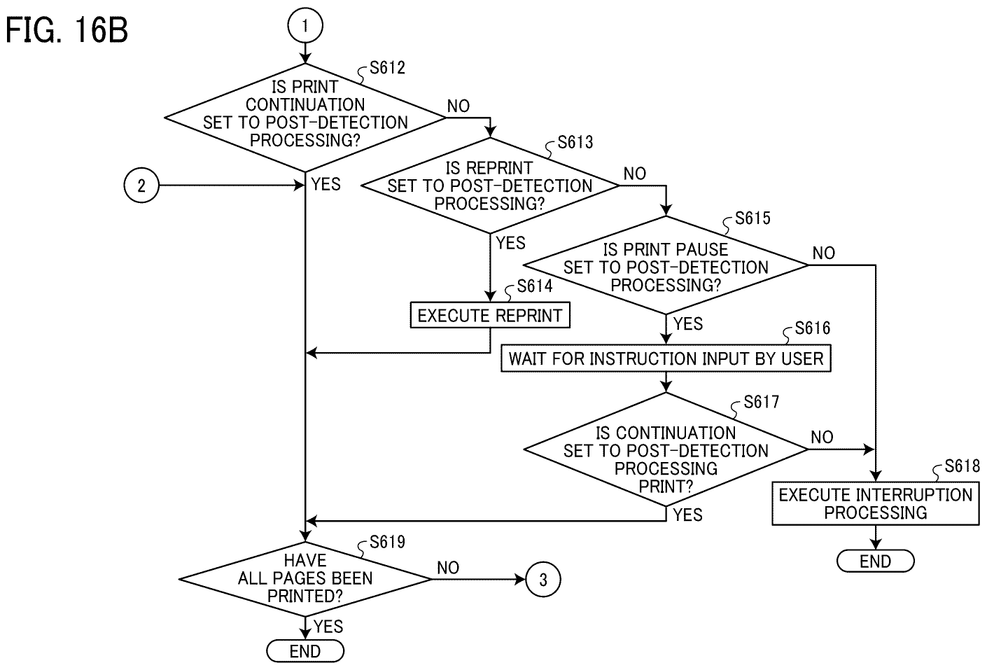

Image inspection processing executed by the image inspection apparatus 103 included in the image forming system 1 configured as described above is described below. FIGS. 16A and 16B are flowcharts of the image inspection processing executed in the image inspection apparatus 103. In step S601, the inspection target image acquisition unit 407 acquires an image obtained by the reading device 131 or the reading device 132 reading a printed matter. The image obtained by the reading device 131 or the reading device 132 reading a printed matter is an inspection target image.

In step S602, in the image inspection apparatus 103, the difference image generation unit 409 generates a difference image between the master image and the inspection target image, and the defect determination unit 453 inspects the printed matter, that is, the inspection target image, for a defect. In step S603, the defect determination unit 453 determines whether a defect is present on the inspection target image. In the case where it is determined that no defect is present on the inspection target image (NO in step S603), in step S620, the processing execution unit 457 sets the consecutive occurrence flag stored in the storage unit 451 to off. Then, the processing proceeds to step S619.

In the case where it is determined that a defect is present on the inspection target image (YES in step S603), it is checked whether the defect has consecutively occurred. In other words, in step S604, the defect determination unit 453 determines whether the consecutive occurrence flag stored in the storage unit 451 is set to off. In the case where the consecutive occurrence flag is set to off (YES in step S604), in step S605, the defect determination unit 453 sets the consecutive occurrence flag to on and sets the number of occurrences, which is a counter, to one. On the other hand, in the case where the consecutive occurrence flag is set to on (NO in step S604), the defect determination unit 453 adds one to the number of occurrences in step S606. In step S607, the defect determination unit 453 determines whether the number of occurrences is less than the number of pages set in the consecutive occurring pages in one of the priority tables of FIGS. 5 to 8 determined to be referred to in advance. In the case where the number of occurrences is not less than the number of pages set in the consecutive occurring pages, that is, in the case where the number of occurrences reaches the number of pages set in the consecutive occurring pages (NO in step S607), the processing determination unit 454 determines the post-detection processing corresponding to the consecutive occurring pages in the priority table in step S608.

On the other hand, in the case where the number of occurrences is less than the number of pages set in the consecutive occurring pages (YES in step S607), the processing proceeds to step S609.

In step S609, the defect determination unit 453 determines whether multiple types of defects or errors are detected. In the case where only one type of defect or error is detected (NO in step S609), the processing determination unit 454 determines the post-detection processing for the detected defect or error in the priority table in step S611. Then, the processing proceeds to step S612.

On the other hand, in the case where multiple types of defects or errors are detected (YES in step S609), in step S610, the defect determination unit 453 refers to the priority table. In step S621, the processing determination unit 454 determines, as the subsequent processing, the post-detection processing for the type of defect having the highest priority in the priority table among the types of post-detection processing for the multiple types of detected defects. The processing determination unit 454 notifies the processing execution unit 457 of the content of the post-detection processing determined in step S611 or S621.

In step S612, the processing execution unit 457 determines whether the post-detection processing determined by the processing determination unit 454 is the “print continuation.” In the case where the post-detection processing determined by the processing determination unit 454 is determined to be the “print continuation” (YES in step S612), the printing is continued. Then, the processing proceeds to step S619.

On the other hand, in the case where the post-detection processing determined by the processing determination unit 454 is determined not to be the “print continuation” (NO in step S612), the processing execution unit 457 determines whether the post-detection processing determined by the processing determination unit 454 is “reprint” in step S613. In the case where the post-detection processing determined by the processing determination unit 454 is determined to be the “reprint” (YES in step S613), the processing execution unit 457 executes processing for the reprint in step S614. Then, the processing proceeds to step S619.

On the other hand, in the case where the post-detection processing determined by the processing determination unit 454 is determined not to be the “reprint” (NO in step S613), the processing execution unit 457 determines whether the post-detection processing determined by the processing determination unit 454 is the “print pause” in step S615. In the case where the post-detection processing determined by the processing determination unit 454 is determined not to be the “print pause” (NO in step S615), the processing execution unit 457 executes processing for interruption in step S618. Then, the processing ends.

On the other hand, in the case where the post-detection processing determined by the processing determination unit 454 is determined to be the “print pause” (YES in step S615), the processing execution unit 457 causes the operation panel 133 to display a print pause screen on the display and waits for an instruction to be input by the user.

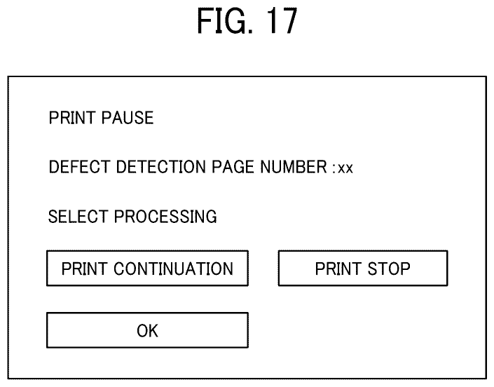

FIG. 17 is a diagram illustrating the print pause screen. On the print pause screen, as illustrated in FIG. 17, the page number of the page on which the defect is detected is displayed. In addition, on the print pause screen, buttons for allowing the user to select processing are displayed. As illustrated in FIG. 17, the “print continuation” and the “print stop” are displayed as processing options selectable by the user. When the printing is paused, the user checks the content of the defect on the operation panel 133 and selects one of the print continuation or the print stop. After the user selects one of the buttons, the selected processing is executed by the user pressing an “OK” button (i.e., an input by touch).

In step S616, the processing execution unit 457 receives an instruction input by the user through the print pause screen. In step S617, the processing execution unit 457 determines whether the processing input by the user is the “print continuation.” In the case where the processing input by the user is determined not to be the “print continuation” (NO in step S617), the processing execution unit 457 executes processing for interruption in step S618. Then, the processing ends. In the case where the processing input by the user is determined to be the “print continuation” (YES in step S617), the processing proceeds to step S619.

The image inspection apparatus 103 performs the defect inspection, the checking of the consecutive occurrences of a defect, and the checking of the result of the defect detection as described above for each page, determines post-detection processing with the processing determination unit 454, and executes the post-detection processing determined by the processing determination unit 454 with the processing execution unit 457. In step S619, the processing execution unit 457 determines whether printing of all pages is completed. In the case where it is determined that the printing of all pages is not completed (NO in step S619), the processing returns to step S601, the defect inspection, the checking of the consecutive occurrences of a defect, and the checking of the result of the defect detection described above are repeatedly executed. On the other hand, in the case where it is determined that the printing of all pages is completed (YES in step S619), the print job is determined to be completed and the processing ends.

According to techniques in the art, when multiple different types of defects are detected on the same page, there is a possibility that the post-detection processing intended by the user may not be executed. For example, according to a technique in the art, the post-detection processing can be set in advance according to the type of defect before an output recording medium is inspected. However, when different types of defects are detected on the same page as described above, the user cannot predict for which type of defect the post-detection processing is executed. As a result, after printing, it may be discovered that the post-detection process that has been executed is not the post-detection process intended by the user.

In contrast, the image inspection apparatus 103 includes the inspection target image acquisition unit 407 that acquires an inspection target image obtained by reading a printed matter printed by the image forming apparatus 101, the defect determination unit 453 that determines whether a defect is present on the printed matter based on the inspection target image and the master image to be compared with the inspection target image, the processing determination unit 454 that, when a defect is detected, determines post-detection processing determined in advance for the defect as the subsequent processing based on the priority determined in advance according to the type of defect to which the detected defect belongs, and the processing execution unit 457 that executes the post-detection processing determined by the processing determination unit 454.

Specifically, the image inspection apparatus 103 determines whether a defect is present on the printed matter based on a result of the comparison between the master image and the inspection target image. In addition, in the image inspection apparatus 103, a priority table is set in advance, in which a defect, post-detection processing when the defect is detected, and a priority for the defect are set in association with one another. As a result, when multiple different defects are detected on the same page, the post-detection processing for the defect having a higher priority can be determined based on the priority set in the priority table. Thus, according to the image inspection apparatus 103 of the present embodiment, even when multiple different defects are detected on the same page as described above, the post-detection processing intended by the user is executed by setting a priority indicating the order of execution of the post-detection processing in advance to each defect. Further, the present embodiment can be applied not only to the inspection of a two-dimensional image such as the printed matter but also to the inspection of a three-dimensional object created by, for example, a three-dimensional (3D) printer.

In the image inspection apparatus 103, when multiple different defects are detected on the same page by the defect determination unit 453, the processing determination unit 454 determines the post-detection processing for the defect having the highest priority among the types of post-detection processing for the respective types of defects to which the detected multiple different defects belong in one of the priority tables 4051 to 4054 determined to be referred to in advance. Thus, when multiple types of defects are detected, a priority indicating the order of execution of the post-detection process desired by the user can be set to each of the multiple types of defects.

According to the image inspection apparatus 103 of the present embodiment, in the priority tables 4051 to 4054, the size level or the density level of a defect is associated with post-detection processing for each type of defect. The processing determination unit 454 determines the post-detection processing for the size level or the density level of a defect to be detected. Thus, different post-detection processing can be set for each size level or each density level of a defect to be detected. Thus, the post-detection processing that is more in line with the intention of the user is executed.

According to the image inspection apparatus 103 of the present embodiment, in the priority tables 4051 to 4054, the type of defect, the priority, and the post-detection processing to be executed when a defect is detected on multiple consecutive pages are associated with one another. Thus, in the case where a defect is detected on multiple consecutive pages, the occurrence of the waste sheets can be reduced.

According to the image inspection apparatus 103 of the present embodiment, in the priority tables including, as the type of defect, the alignment error when the master image and the inspection target image are compared, the alignment error and the processing to be executed as the post-detection processing when an alignment error occurs are associated with each other. Thus, when the detection of a defect is not correctly performed, the detection is stopped.

According to the image inspection apparatus 103 of the present embodiment, in the priority tables 4051 to 4054, the defect and the post-detection processing are associated with each other for each shape of the defect by type of defect. Thus, the user can set the post-detection processing for each shape of the defect.

Further, the image inspection apparatus 103 includes the priority setting unit 455 that registers, in the priority tables 4051 to 4054, post-detection processing and a priority in association with each other for each type of defect. Thus, the user can set the post-detection processing on the operation panel 133 for each size level or each density level of a defect to be detected and each shape of the defect, and the contents set in the priority tables 4051 to 4054 can be stored in the storage unit 405. Thus, the priority and the post-detection processing can be changed. Thus, the processing is flexibly set and executed.

In the image inspection apparatus 103, the priority setting unit 455 displays, on the display, the setting screen allowing the user to input post-detection processing and a priority in association with each other for each type of defect, and registers the type of defect, the post-detection processing, and the priority input on the setting screen in the priority tables 4051 to 4054 in association with one another. Thus, the contents of the settings set in the priority tables 4051 to 4054 are displayed on the display of the operation panel 133, and the settings can be referred to or changed.

In the image forming system, the image forming apparatus 101 executes printing on a sheet to create a printed matter, the image inspection apparatus 103 includes the inspection target image acquisition unit 407 that acquires an inspection target image obtained by reading the printed matter printed by the image forming apparatus 101, the defect determination unit 453 that determines whether a defect is present on the printed matter based on the inspection target image and the master image to be compared with the inspection target image, the processing determination unit 454 that, when a defect is detected, determines post-detection processing determined in advance for the defect as the subsequent processing based on the priority determined in advance according to the type of defect to which the detected defect belongs, and the processing execution unit 457 that executes the determined post-detection processing. Thus, according to the image inspection apparatus 103 of the present embodiment, even when multiple different defects are detected on the same page as described above, the post-detection processing intended by the user is executed by setting a priority indicating the order of execution of the post-detection processing in advance to each defect.

An image inspection method executed by the image inspection apparatus 103 and a non-transitory recording medium include acquiring an inspection target image obtained by reading a recording medium on which the image is formed by an image forming apparatus, determining whether a defect is present on the recording medium based on the inspection target image and a master image to be compared with the inspection target image, in the case where the defect is detected on the recording medium based on the master image and the inspection target image, determining post-detection processing that is determined in advance for the defect based on a priority determined in advance according to the type of defect to which the detected defect belongs and is to be executed in response to an occurrence of the defect. Thus, even when multiple different defects are detected on the same page, the post-detection processing intended by the user is executed by setting a priority indicating the order of execution of the post-detection processing in advance to each defect.

In the embodiments described above, the types of defects, the post-detection processing, and the priorities are set in advance in the priority tables 4051 to 4054. However, these items do not necessarily need to be set in advance. For example, the processing determination unit 454 may be configured to determine the post-detection processing based on the type and the priority of a defect during processing.

The image forming apparatus has been described as a multifunction peripheral (MFP) having at least two of copying, printing, scanning, and facsimile functions. However, the present disclosure can be applied to any image forming apparatus, such as a copier, printer, scanner, or facsimile machine. The functions described in the embodiments may be provided by being implemented in an ASIC or by a computer executing programs. In the latter case, the programs may be provided as the functional units by being installed in, for example, a ROM or an HDD. In this case, the CPU reads out the programs and executes the programs step by step to implement the functional units. Alternatively, the programs may be stored in a computer-readable storage medium and provided as a computer program product. For example, the programs are stored in any computer-readable storage medium, such as an FD, a CD-R, a DVD, a BLU-RAY disc, or a semiconductor memory, in an installable or executable file format and provided as a computer program product.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image inspection apparatus comprising circuitry configured to:
read a recording medium on which an image is formed by an image forming apparatus to acquire an inspection target image;
determine whether a defect is present on the recording medium based on the inspection target image and a master image to be compared with the inspection target image;
in a case that the defect is detected on the recording medium based on the master image and the inspection target image;
determine post-detection processing to be executed in response to an occurrence of the defect, the post-detection processing having been determined in advance for the defect based on a priority determined in advance according to a type of the defect; and
execute the post-detection processing.

2. The image inspection apparatus according to claim 1, further comprising a memory that stores a priority table in which the type of defect, the post-detection processing, and the priority are associated with one another,
wherein the circuitry is configured to, in the case that the defect is detected on the recording medium based on the master image and the inspection target image, determine the post-detection processing for the defect based on the priority corresponding to the type of the defect in the priority table.

3. The image inspection apparatus according to claim 2,
wherein the circuitry is configured to, in a case that a plurality of different defects are detected on a same page, determine the post-detection processing for the defect having a highest priority among types of post-detection processing for respective types of the plurality of different defects in the priority table.

4. The image inspection apparatus according to claim 2,
wherein:
the priority table associates a level indicating a degree of a size of the defect or a density of the defect, and the post-detection processing with each other for each type of the defects; and
the circuitry is configured to determine the post-detection processing associated with the level of the size or density of the defect that is determined.

5. The image inspection apparatus according to claim 2,
wherein the priority table associates the type of defect, the priority, and the post-detection processing to be executed in a case that the defect is detected on a plurality of consecutive pages with one another.

6. The image inspection apparatus according to claim 2,
wherein:
the type of defect includes an alignment error indicating a deviation occurring in a case that the master image and the inspection target image are compared; and
the priority table associates the alignment error and processing to be executed as the post-detection processing in a case that the alignment error occurs with each other.

7. The image inspection apparatus according to claim 2,
wherein the priority table associates the defect and the post-detection processing with each other for each shape of the defect by type of defect.

8. The image inspection apparatus according to claim 2,
wherein the circuitry is further configured to register, in the priority table, the post-detection processing and the priority in association with each other for each type of defect.

9. The image inspection apparatus according to claim 8,
wherein the circuitry is further configured to:
display, on a display, a setting screen allowing a user to input the post-detection processing and the priority in association with each other for each type of defect; and
register, in the priority table, the type of defect, the post-detection processing, and the priority in association with one another.

10. An image forming system comprising:
an image forming apparatus to form an image on a recording medium; and
an image inspection apparatus including circuitry configured to:
read the recording medium to acquire an inspection target image;
determine whether a defect is present on the recording medium based on the inspection target image and a master image to be compared with the inspection target image;
in a case that the defect is detected on the recording medium based on the master image and the inspection target image, determine post-detection processing to be executed in response to an occurrence of the defect, the post-detection processing having been determined in advance for the defect based on a priority determined in advance according to a type of the defect; and
execute the post-detection processing.

11. An image inspection method comprising:
reading a recording medium on which an image is formed by an image forming apparatus to acquire an inspection target image;
determining whether a defect is present on the recording medium based on the inspection target image and a master image to be compared with the inspection target image;
in a case that the defect is detected on the recording medium based on the master image and the inspection target image, determining post-detection processing to be executed in response to an occurrence of the defect, the post-detection processing having been determined in advance for the defect based on a priority determined in advance according to a type of the defect; and
executing the post-detection processing.

12. A non-transitory recording medium storing a plurality of program codes which, when executed by one or more processors, causes the one or more processors to perform the method according to claim 11.
